(19) United States
(12) Patent Application Publication
(10) Pub. No.: US 2011/0055845 A1
(43) Pub. Date: Mar. 3, 2011

(54) Technique for balancing loads in server clusters

(76) Inventors: Thyagarajan Nandagopal, Edison, NJ (US); Thomas Y. Woo, Short Hills, NJ (US)

(21) Appl. No.: 12/584,107

(22) Filed: Aug. 31, 2009

(51) Int. Cl. G06F 9/46

(52) U.S. Cl. 718/105

(57) ABSTRACT

In a network arrangement where a client requests a service from a server system, e.g., through the Internet, a multiple-load balancer is used for balancing loads in two or more server clusters in the server system to completely identify a sequence of servers for processing the service request. Each server in the resulting sequence belongs to a different server cluster. The service request is sent to the first server in the sequence, along with information for routing the request through the sequence of servers.

### FIELD OF THE INVENTION

The invention relates to a server processing technique and, more particularly, to a technique for processing a service request from a client.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Client-server communications are common in computer and communication network environments, e.g., the Internet. For example, when accessing a website on the Internet, a user at a personal computer (a client) establishes an hypertext transfer protocol (HTTP) connection with a server system (a server) hosting the website to request a service from the server system. Each client and server on a network are considered network nodes which are identified by network addresses, e.g., Internet protocol (IP) addresses. For example, a server system on the Internet may alternatively be identified by a domain name for ease of memorization, which is translatable to its IP address in accordance with a well established domain name system. In a well known manner, information is forwarded from one network node to another in the form of a packet which includes, e.g., a source IP address from which the packet originates, and a destination IP address to which the packet is destined.

A server system usually needs to respond to service requests from multiple clients at the same time. The resulting workload required of the server system at times may exceed its capacity, e.g., available bandwidth, memory, processing clock-cycles, etc. To solve one such overload problem, backend servers typically are added to the server system to increase its capacity. Backend servers in a server system may be grouped in clusters. Each backend server in a cluster typically is assigned to provide the same service or function, e.g., file transfer pursuant to a file transfer protocol (FTP), a domain name service (DNS), etc.

A load balancer oftentimes is used in the server system to balance the service load imposed on a server cluster across the backend servers in the cluster. The load balancer may be a dedicated device that performs only load balancing, or a software program running on a computer. The collection of a load-balancer and the server cluster associated therewith sometimes is referred to as a “service group.”

A packet received by a server system, e.g., on the Internet, typically is processed by several service groups in serial, where each service group performs a different task. For example, a server system may subject a received packet to deep-packet inspection/firewalling, and then a CALEA (Communications Assistance for Law Enforcement Act) inspection before servicing a client request, e.g., outputting streaming video. A service-chain selector determines a sequence of services, referred to as a “service chain,” for each received packet, and may make different service-chain determinations for individual received packets.

A service chain specifies a sequence of service groups—not the specific backend server within each service group—which will process a received packet. For example, a first packet may be afforded a service chain consisting of service group A, followed by service group B and then service group C (denoted A-B-C), while a second packet may be afforded a service chain of C-A. A separate load balancer in each service group of the service chain determines the actual backend server in the service group that will process the received packet. The sequence of the specific backend servers which are assigned by the respective load balancers to process the received packet is referred to as a “server path.”

FIG. 1 illustrates a typical network arrangement 100 where client 102 requests a service from server system 104. The latter includes service-chain selector 108 and three service groups A, B, and C. Service group A includes load balancer LB_{A} and four backend servers A1 A2, A3, and A4. Service group B includes load balancer LB_{B} and two backend servers B1 and B2. Service group C includes load balancer LB_{C} and three backend servers C1, C2, and C3. Dotted lines connecting a load balancer to a backend server indicate that the load balancer can route a packet to the backend server, depending on its share of workload.

Client 102 sends packet 106 to server system 104 where service-chain selector 108 in this instance determines that the service chain for packet 106 is A-B-C. Accordingly, service-chain selector 108 sends packet 106 to load balancer LB_{A} in service group A. In this example, load balancer LB_{A} assigns the packet to back-end server A4 for processing, in accordance with its load balancing algorithm. After server A4 processes (e.g., performs deep-packet inspection and firewalling on) the packet, it sends the packet to load balancer LB_{B} in service group B. Load balancer LB_{B} assigns the packet to back-end server B2 for processing, in accordance its load balancing algorithm. After server B2 processes (e.g., performs CALEA inspection on) the packet, it sends the packet to load balancer LB_{C} in service group C. Load balancer LB_{c} then routes the packet to back-end server C1 for providing the requested service, e.g., streaming video. Thus, in this instance, the service chain for packet 106 determined by selector 108 is A-B-C, and the server path determined by load balancers LB_{A}, LB_{B} and LB_{C} serially for packet 106 is A4-B2-C1.

### BRIEF SUMMARY

The invention stems from a recognition that it is inefficient to use a load balancer to determine only for the cluster associated therewith, a server in the cluster (i.e., a single “hop” in a server path) to process a service request, as in the typical network arrangement described above. In other words, each cluster requires its own load balancer in the typical network arrangement, which is inefficient.

In accordance with an embodiment of the invention, a multiple-load balancer is used to identify a sequence of servers for processing a service request. The servers in the sequence are associated with different server clusters, respectively. By balancing loads in the server clusters, the multiple-load balancer completely identifies the sequence of servers before the service request is processed by any one of the servers in the sequence.

### BRIEF DESCRIPTION OF THE DRAWING

Other aspects, features, and advantages of the invention will become more fully apparent from the following detailed description, the appended claims, and the accompanying drawing in which:

FIG. 1 is a block diagram of a typical network arrangement;

FIG. 2 is a block diagram of a network arrangement according to one embodiment of the invention;

FIG. 3 is a flowchart depicting a process performed in the network arrangement of FIG. 2 according to a first embodiment of the invention;

FIG. 4 is a block diagram of a multiple-load balancer used in the network arrangement of FIG. 2 according to one embodiment of the invention;

FIG. 5 is a flowchart depicting a process performed in the network arrangement of FIG. 2 according to a second embodiment of the invention; and

FIG. 6 is a flowchart depicting a process performed in the network arrangement of FIG. 2 according to a third embodiment of the invention.

### DETAILED DESCRIPTION

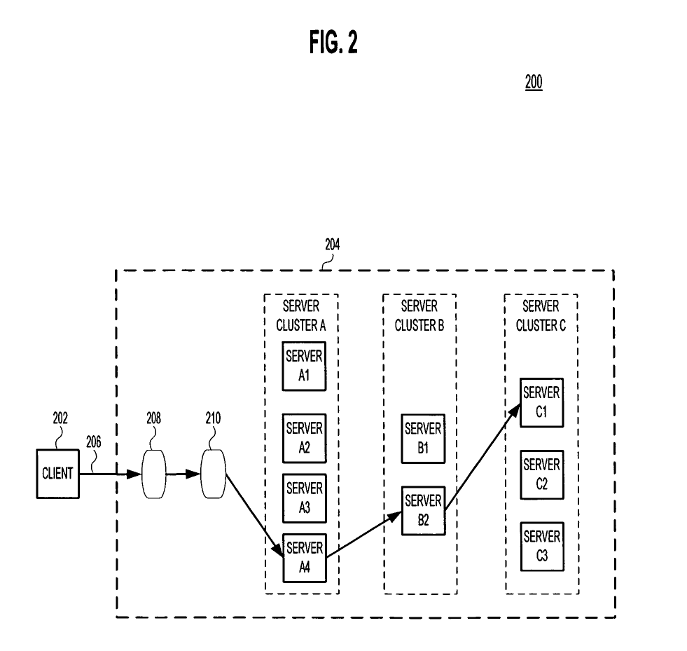

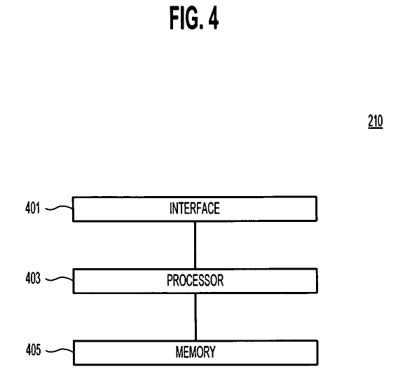

FIG. 2 illustrates a network arrangement 200 embodying the principles of the invention, where a client 202 requesting a service from a server system 204, e.g., through the Internet. Server system 204 includes service-chain selector 208, multiple-load balancer 210 (also shown in FIG. 4), and server clusters A, B, and C. By way of example, client 202 sends a packet 206 which incorporates a service request to server system 204. Without loss of generality, service-chain selector 208 within server system 204 determines a service chain of A-B-C for the packet, and forwards the packet to multiple-load balancer 210. It should be noted that although only server clusters A, B, and C are shown in server system 204, server system 204 may include N different server clusters, where N≧2. In addition, the service chain A-B-C for packet 206 here is for illustrative purposes. Indeed, another packet may follow service chain C-A, A-B, etc.

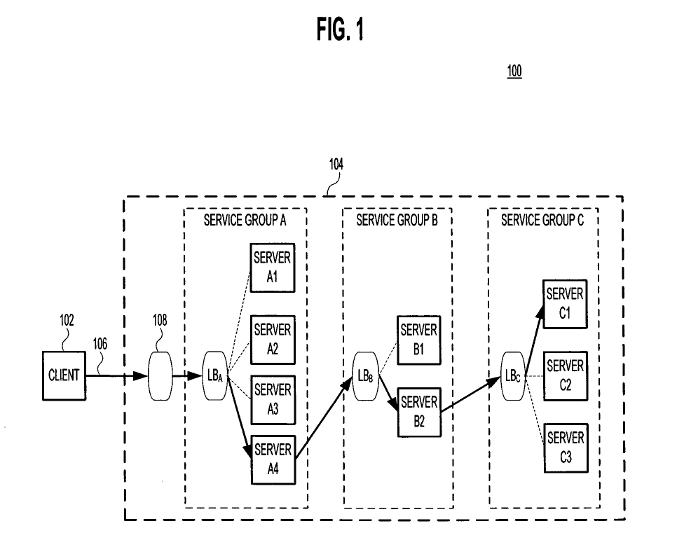

In accordance with an embodiment of the invention, multiple-load balancer 210 is used to balance individual loads imposed on two or more of server clusters A, B and C, respectively. In balancing the loads, balancer 210 determines the entire server path, i.e., the sequence of specific backend servers in the respective clusters, through which packet 206 is to be routed before it sends the packet to the server clusters for processing thereof. Thus, unlike a typical load balancer, e.g., load balancer LB_{A} of FIG. 1, which determines only the next hop or server in the server path, multiple-load balancer 210 determines the entire server path for packet 206, e.g., server path A4-B2-C1 in a single process. Specifically, multiple-load balancer 210 in the same process identifies server A4 to process packet 206 to keep the loads of the servers in cluster A balanced, server B2 to process packet 206 to keep the loads of the servers in cluster B balanced, and server C1 to process packet 206 to keep the loads of the servers in cluster C balanced. Although part of the algorithm used in balancer 210 for evenly distributing the load for a cluster amongst the individual servers in the cluster is well known, the invention is premised upon the recognition of use of a single balancer, i.e., balancer 210, to balance the respective loads for multiple clusters all in the same process. Importantly, balancer 210 also is programmed to effectively route a packet through a server path after the entire server path is identified by the balancer for the packet, in accordance with various embodiments of the invention.

To better understand the various embodiments to be described, three concepts, namely, flow IDs, server IDs and tagging will now be explained. A flow ID is a unique identifier assigned to a group of associated packets, referred to as a “flow.” For example, all packets having the same source IP address or other characteristics may be considered a flow. Thus, multiple-load balancer 210 may define all received packets having a source address of 192.168.1.1 as belonging to a flow having flow ID 2201. Although balancer 210 may route packets from the same flow through different server paths for processing thereof, in the various embodiments, for efficiency the packets belonging to the same flow are routed through the same server path.

A server ID is a unique identifier assigned to a backend server for its identification. The server ID may be an arbitrary value assigned by a server system administrator, or it may be an existing address of the server such as the server's media access control (MAC) address, IP address, etc.

Tagging refers to the encapsulation of a first packet inside a second packet called a tagged packet, which contains a field value—a tag—used by downstream servers to route/process the tagged packet without having to inspect the contents of the encapsulated first packet.

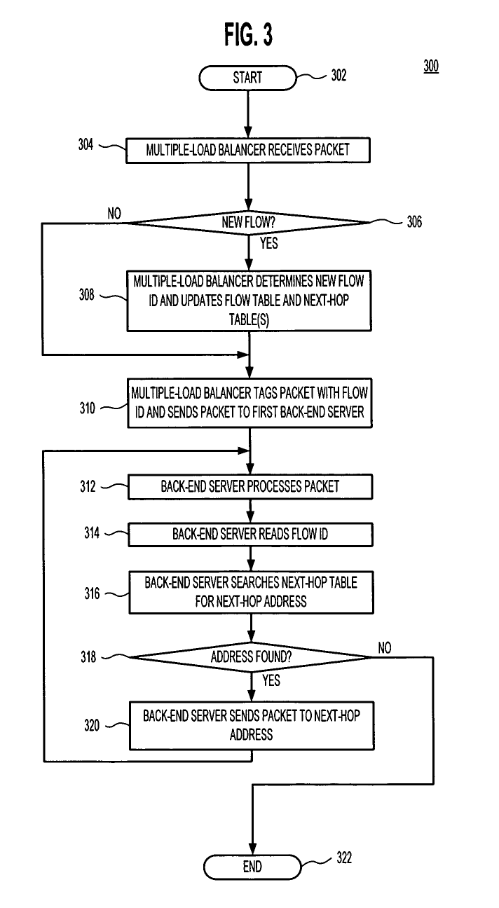

FIG. 3 illustrates a flow-ID process 300, which is implemented in server system 204, and which involves tagging (i.e., encapsulating) packets with a flow-ID value, in accordance with one embodiment of the invention. Process 300 starts at step 302 and proceeds to step 304, where multiple-load balancer 210 receives a packet through its interface 401 in FIG. 4. At step 306, processor 403 in multiple-load balancer 210 determines if the packet belongs to an existing flow or a new flow. Specifically, processor 403 consults a flow table which is stored in memory 405, and which associates a flow ID with the characteristics that define the flow.

If it is determined at step 306 that the packet belongs to a previously identified flow, then process 300 continues to step 310. Otherwise, if it is determined that the packet belongs to a new flow, at step 308 processor 403 determines a new flow ID, say, 2201. Processor 403 also identifies a server path for the new flow, say, A4-B2-C1 after it performs load balancing for the respective server clusters A, B and C. Processor 403 then updates the flow table in memory 405 by adding a record thereto which contains new flow ID 2201 and characteristics (e.g., the source IP address of the packet) that define flow ID 2201. Processor 403 also updates a next-hop table in each backend server in the server path just identified, except that of the last backend server in the path. Specifically, for each backend server, except the last backend server, in the server path, a new record is added to the next-hop table stored in the backend server. The new record for the backend server contains new flow ID 2201, and in association therewith a routable address (e.g., IP or MAC address) of the next backend server (i.e., the next hop) in the server path. In this instance, a new record is added to the next-hop table on server A4, which contains flow ID 2201 and, in association therewith, an IP address of backend server B2. In addition, a new record is added to the next-hop table on server B2, which contains flow ID 2201 and, in association therewith, an IP address of backend server C1.

At step 310, processor 403 tags the received packet with the packet's flow ID, and sends the resulting tagged packet to the first backend server in the server path (i.e., backend server A4 in this instance). At step 312, the backend server processes the packet, which process involves inspecting the packet, modifying the packet, and/or performing an action towards fulfilling the service request in the packet.

At step 314, the backend server reads the flow-ID tag from the tagged packet. At step 316, the backend server searches its next-hop table for the next-hop address associated with the flow ID. If the address is found at step 318, the backend server at step 320 sends the packet which may have been modified thereby to the address of the next backend server in the server path. The next backend server then repeats steps 312-320. However, if at step 318, no next-hop address associated with the flow ID is found, process 300 comes to end, as indicated at step 322.

In some embodiments, a packet received by balancer 210 is tagged with a server-path ID before it is routed to the first backend server in the server path. In one embodiment, a server-path ID includes server IDs which are addresses taken from a pre-defined address-space, e.g., MAC addresses or IP addresses of backend servers. In another embodiment, a server-path ID includes server IDs which are selected from a user-defined virtual-ID space.

In general, a server ID consists of a binary bit string having a bit length L_{ID}=log₂ ID_{MAX}, where ID_{MAX} represents the maximum number of possible server IDs. For example, when given the bit length of a MAC address for a server ID L_{ID}=48 bits, ID_{MAX}=2⁴⁸. In some embodiments, the address space also contains a terminator value, e.g., a string of zeroes of length L_{ID}, which is used to indicate that packet processing is complete.

In some embodiments, although server paths may vary in length, all server-path IDs are made the same length for more efficient processing. For example, referring to FIG. 2, a first flow may be routed through server path A1-C2, while a second flow may be routed through server path A4-B2-C1. Although these two server paths have different lengths, the server-path IDs corresponding to the two server paths may be adjusted to the same length. Specifically, in some embodiments, a value Sₘₐₓ may be defined to indicate the maximum allowable number of backend servers in a server-path. In addition to the backend servers in the server path, a server-path ID indicates the end of the path, either by specifying the address of an egress device (e.g., an egress router/traffic aggregator) or by using the terminator value. In one such embodiment, the maximum length of a server-path ID SPₘₐₓ may be defined, which equals L_{ID} (Sₘₐₓ+1). A server-path ID whose length is shorter than SPₘₐₓ may be padded with a selected terminator value to make it up to SPₘₐₓ. Thus, for example, if Sₘₐₓ=3, and the end of the server path is indicated by a terminator value of 00, then the two server-path IDs the server paths A1C2 and A4B2C1 may be represented by A1C20000 and A4B2C100, respectively, which have the same SPₘₐₓ.

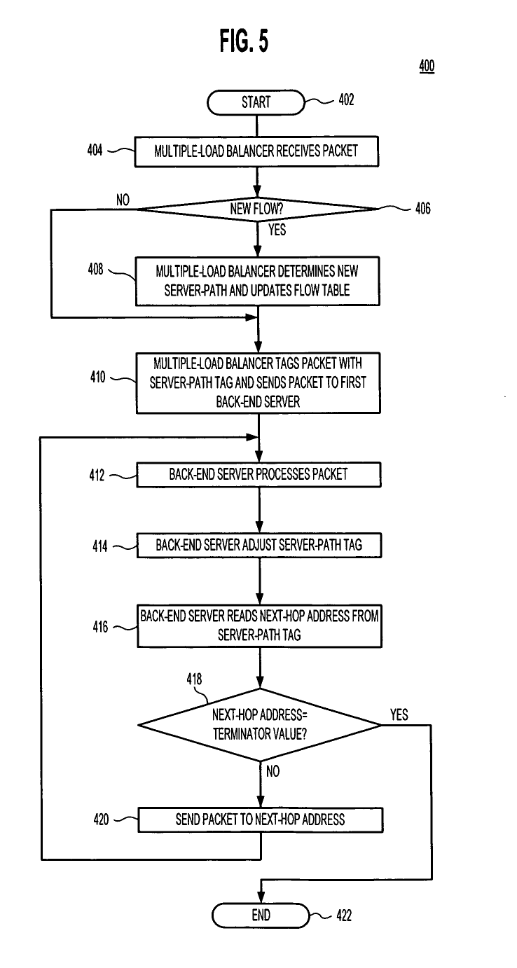

FIG. 5 illustrates process 400 where the MAC (or IP) address of a backend server is used as a server ID of the backend server according to one embodiment of the invention. Since steps 402, 404, 406 and 412 in process 400 are analogous to respective ones of steps 302, 304, 306 and 312 in process 300 previously described, description of the former steps is omitted for brevity.

However, in process 400, processor 403 in multiple-load balancer 210 at step 408 determines a server path for the newly-identified flow, and updates a flow table stored in memory 405 by adding a new record thereto which includes a new flow ID, a server path through which the new flow traverses, and identifying characteristics of the new flow. At step 410, processor 403 tags the received packet with a server-path ID, and sends the tagged packet to the first backend server in the server path which corresponds to the current flow, and which is identified by the server path ID. The tag of the tagged packet which consists of the server-path ID is referred to as a “server-path tag,” and which in this instance contains a concatenation of IP (or MAC) addresses of the backend servers in the server path, followed by a terminator value.

As indicated at step 414, having received and processed the tagged packet, the backend server adjusts the server-path tag therein. In one implementation, the backend server adjusts it by shifting the bits of the server-path tag to the left by L_{ID} bits, thereby obliterating the server ID of the backend server currently processing the packet, while appending the same number of zeroes to the right of the server-path tag to keep the length of the tag constant at SPₘₐₓ. In another implementation, the backend server rotates the bits of the server-path tag to the left by L_{ID} bits, thereby preserving the server ID of the backend server currently processing the packet while keeping the length of the tag constant at SPₘₐₓ.

At step 416, the backend server reads the first L_{ID} bits in the adjusted server-path tag which constitute the next-hop address, i.e., the address of the next backend server in the server-path. At step 418, the backend server determines whether the next-hop address equals the terminator value. If so, process 400 terminates at step 422. Otherwise, at step 420, the packet is sent to the next-hop address for processing by the next backend server in the server path, which repeats steps 412-420.

In some embodiments, virtual IDs may be assigned by a system administrator to identify backend servers in server system 204. The size of the virtual-ID address space, ID_{MAX}, is determined by the number of backend servers in a server system, and may be significantly smaller than the IP or MAC address space. For example, server system 204 including nine backend servers requires, at most, a 4-bit address space (i.e., ID_{MAX}=16), compared with the 48-bit MAC or 128-bit IP address space. In one embodiment, a virtual-ID table is maintained on each backend server and on the multiple-load balancer. Each record in the virtual-ID table contains a virtual ID identifying a backend server, and its routable address (e.g., MAC or IP address). The table may be edited when a backend server is added or removed. Since the virtual-ID table is used here by a backend server for looking up the address of the next backend server for processing a packet, it is also referred to as a “next-hop virtual-ID table.”

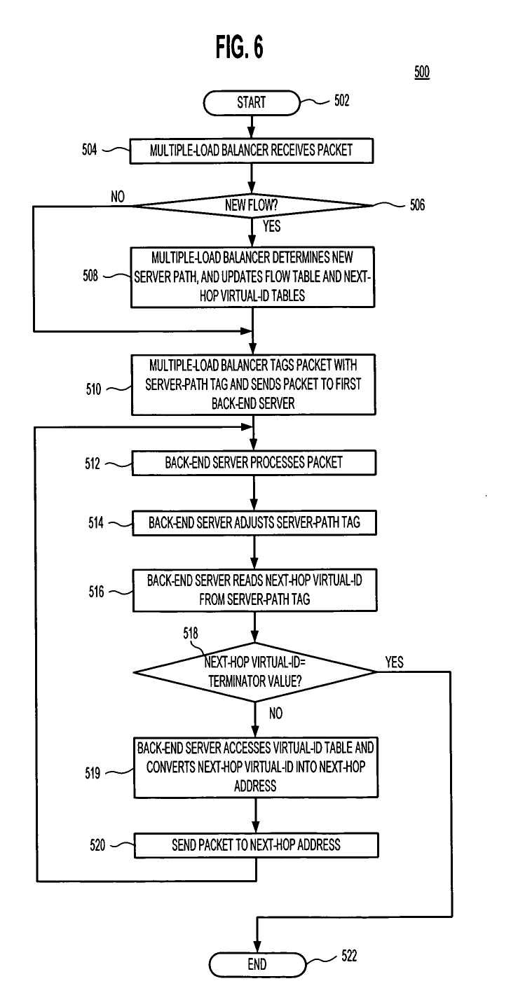

FIG. 6 illustrates process 500 where virtual IDs are used to identify the backend servers in server system 204 according to one embodiment of the invention. Since steps 502, 504, 506 and 512 in process 500 are analogous to respective ones of steps 402, 404, 406 and 412 in process 400 previously described, description of the former steps is omitted here for brevity.

However, in process 500, processor 403 of multiple-load balancer 210 at step 508 determines the server path for the newly-identified flow whose server-path ID includes pre-assigned virtual IDs of the backend servers in the server path. In this instance, the length of each virtual ID L_{ID}=4 bits. Processor 403 then updates a flow table stored in memory 405 by adding thereto a record which includes a new flow ID, a server path through which the new flow traverses, and identifying characteristics of the new flow. Processor 403 also checks a next-hop virtual-ID table maintained on each backend server in the server path. Specifically, it determines whether the backend server has an entry in its next-hop virtual-ID table for the next backend server in the server path. If not, processor 403 updates the next-hop virtual-ID table of the backend server by adding a record thereto, which includes the virtual ID of the next backend server in the server path and the next backend server's routable address (e.g., its IP or MAC address).

At step 510, processor 403 tags the received packet with a server-path ID which in this instance contains a concatenation of virtual IDs of the backend servers in the server path for the current flow, followed by a terminator value, and sends the tagged packet to the first backend server in the server path. Let's assume that in this instance (a) the server path for the packet is A4-B2-C1, (b) the virtual IDs for backend servers A4, B2, and C1 are 0001, 0010, and 0011 respectively, and (c) the terminator value is 0000, the virtual-server-path ID in this instance is 0001001000110000, with SPₘₐₓ=12.

At step 514, having received and processed the tagged packet, the backend server adjusts the server-path tag therein. In this instance, backend server A4 adjusts the server-path tag by rotating the virtual-server-path ID in the tag by four bits to yield 0010001100000001. At step 516, the backend server reads the next-hop virtual-ID from the server-path tag, and in particular the first L_{ID}=4 bits thereof. Thus, in this instance, the next-hop virtual ID read by backend server A4 from the rotated server path tag is 0010.

At step 518, the backend server determines whether the next-hop virtual ID equals the terminator value 0000. If so, process 500 terminates at step 522. Otherwise, at step 519, the backend server accesses a virtual-ID table maintained thereon, and converts the next-hop virtual ID into a next-hop address (e.g., MAC or IP address) after it locates the record in the table containing the next-hop virtual ID, and reads the associated next-hop address in the record. At step 520, the backend server sends the tagged packet to the next backend server in the server path at the next-hop address. The next backend server then repeats steps 512-520.

The foregoing merely illustrates the principles of the invention. It will thus be appreciated that those skilled in the art will be able to device numerous arrangements which embody the principles of the invention and are thus within its spirit and scope.

For example, although in the disclosed embodiments multiple-load balancer 210 is separate from service-chain selector 208, it will be appreciated that the multiple-load balancer may be combined with the service-chain selector in a single device or process.

Further, although in the disclosed embodiments a server-path ID is of a fixed length, it will be appreciated that a variable-length server-path ID may be used, instead.

In addition, the disclosed embodiments a backend server utilizes either left-shifting or rotation to adjust a server-path ID. It will be appreciated the backend server may, instead, adjust a server-path ID by masking, e.g., replacing the backend server's address or virtual ID with a string of zeroes.

It should be noted that reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Finally, although server system 204, as disclosed, is embodied in the form of various discrete functional blocks, the server system could equally well be embodied in an arrangement in which the functions of any one or more of those blocks or indeed, all of the functions thereof, are realized, for example, by one or more appropriately programmed processors or devices.

What is claimed is:

1. A server system, comprising:
a plurality of server clusters, each server cluster having at least one server; and
a load balancer configured to:
receive a packet;
perform load balancing for two or more of the server clusters to identify a sequence of servers for processing the packet, wherein each server in the sequence is in a different server cluster; and
completely identify the sequence of servers before the packet is processed by any one of the servers in the sequence.

2. The system of claim 1 wherein the packet is modified to include information for identifying the sequence of servers.

3. The system of claim 2 wherein the information includes data identifying a flow to which the packet belongs.

4. The system of claim 3 wherein a server in the sequence obtains an address of another server in the sequence based on the data.

5. The system of claim 2 wherein the information includes addresses of the servers in the sequence.

6. The system of claim 2 wherein the information is translatable to addresses of the servers in the sequence.

7. The system of claim 1 wherein data identifying at least one server in the sequence is derivable from the information.

8. Load-balancing apparatus, comprising:
an interface for receiving a service request;
a processor configured to identify a sequence of servers for processing the service request, the servers in the sequence being associated with different server clusters, respectively, the sequence of servers being completely identified by balancing loads in the server clusters before the service request is processed by any one of the servers in the sequence.

9. The apparatus of claim 8 wherein information for routing the service request through the sequence of servers is generated before the information, along with the service request, is sent to any one of the servers in the sequence.

10. The apparatus of claim 9 wherein the information includes an address of at least one server in the sequence.

11. The apparatus of claim 10 wherein the address is an IP address.

12. The apparatus of claim 10 wherein the address is a MAC address.

13. The apparatus of claim 9 wherein the information is translatable to an address of at least one server in the sequence.

14. The apparatus of claim 9 wherein data identifying at least one server in the sequence is derivable from the information.

15. A load-balancing method, comprising
receiving a packet;
identifying a sequence of servers for processing the packet, the servers in the sequence being associated with different server clusters, respectively, the sequence of servers being completely identified by balancing loads in the server clusters; and
modifying the packet to include information for routing the packet through the sequence of servers before the modified packet is sent to one of the servers in the sequence.

16. The method of claim 15 wherein the information includes data identifying a flow to which the packet belongs.

17. The method of claim 15 wherein the information includes an address of at least one server in the sequence.

18. The method of claim 17 wherein the address is an IP address.

19. The method of claim 17 wherein the address is a MAC address.

20. The method of claim 15 wherein the information is translatable to an address of at least one server in the sequence.

21. The method of claim 15 wherein data identifying at least one server in the sequence is derivable from the information.
